(19) United States
(12) Patent Application Publication
(10) Pub. No.: US 2026/0259517 A1
(43) Pub. Date: Sep. 3, 2026

(54) IMAGE FORMING APPARATUS

(71) Applicant: CANON KABUSHIKI KAISHA, Tokyo (JP)

(72) Inventors: TSUYOSHI TAJIRI, Tokyo (JP); TATSUYUKI YAMAMOTO, Tokyo (JP); HITOSHI IWAI, Chiba (JP); TOMOTAKA UEKI, Chiba (JP)

(21) Appl. No.: 19/541,931

(22) Filed: Feb. 17, 2026

(30) Foreign Application Priority Data
Mar. 3, 2025 (JP) 2025-032922

(51) Int. Cl. G03G 15/04; G03G 15/043; G03G 15/32; G03G 21/16

(52) U.S. Cl. CPC G03G 15/04036; G03G 15/04054; G03G 15/0435; G03G 15/326; G03G 21/1666

(57) ABSTRACT

An image forming apparatus includes a photosensitive member, an optical print head configured to expose the photosensitive member and include a substrate on which a plurality of light emitting elements is mounted, and a lens array including a plurality of lenses configured to condense light emitted from the light emitting elements on the photosensitive member, a cleaning rod configured to have a longitudinal shape and clean an emission surface of the lens, and a guide member configured to guide the cleaning rod while causing the cleaning rod to abut on the emission surface of the lens. The guide member includes a first restricting portion configured to restrict movement of the cleaning rod abutting on the lens in a direction away from the optical print head, and a second restricting portion configured to restrict movement of the cleaning rod abutting on the first restricting portion in a direction approaching the optical print head.

### BACKGROUND

### Field of the Technology

The present disclosure relates to an image forming apparatus that exposes a photosensitive member by an optical print head.

### Description of the Related Art

Conventionally, as an image forming apparatus of an electrophotographic system, an image forming apparatus in which an electrostatic latent image is formed on a surface of a photosensitive drum from an optical print head including an LED array and a lens array, and toner is attached to the electrostatic latent image to develop a toner image has been widely used.

In such an image forming apparatus, in a case where toner adheres to a light emitting surface of the lens in the optical print head, the light quantity with which the photosensitive drum is irradiated becomes uneven, which may cause deterioration in image quality.

Therefore, a configuration including a cleaning member that cleans a light emitting surface of a lens in an optical print head has been proposed (Japanese Patent Laid-Open No. 2008-173811). Japanese Patent Laid-Open No. 2008-173811 discloses a configuration in which a guide groove is formed in an optical print head along an axial direction of a photosensitive drum, and a hook portion provided in a cleaning member is engaged with the guide groove, so that the cleaning member is caused to abut on a light emitting surface of a lens and can be guided along the guide groove.

However, in the configuration disclosed in Japanese Patent Laid-Open No. 2008-173811, a worker needs to align the hook portion of the cleaning member with the narrow guide groove, and needs to maintain the engagement state during cleaning by the cleaning member. Therefore, in a case where a worker applies an unexpected force to the cleaning member, there is a possibility that the cleaning member is detached from the guide groove, and there is a concern that the cleaning member is not able to clean the lens.

### SUMMARY

According to an aspect of the present disclosure, an image forming apparatus includes a photosensitive member, an optical print head configured to expose the photosensitive member and include a substrate on which a plurality of light emitting elements is mounted along a longitudinal direction that is an axis direction of the photosensitive member, and a lens array including a plurality of lenses configured to condense light emitted from the light emitting elements on the photosensitive member, a cleaning rod configured to have a longitudinal shape, be inserted from an outside of the image forming apparatus, and clean an emission surface of the lens by rubbing the emission surface of the lens in the longitudinal direction, and a guide member configured to guide the cleaning rod inserted from the outside of the image forming apparatus in the longitudinal direction while causing the cleaning rod to abut on the emission surface of the lens, in which the guide member includes a first restricting portion configured to restrict a movement of the cleaning rod abutting on the lens in a direction away from the optical print head, and a second restricting portion that is provided on an upstream side of the first restricting portion in an insertion direction of the cleaning rod and is configured to restrict movement of the cleaning rod abutting on the first restricting portion in a direction approaching the optical print head.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of an image forming apparatus;

FIG. 2 is a view illustrating an image forming portion and a frame body portion that supports the image forming portion;

FIG. 3 is a view illustrating a drum unit and a developing unit;

FIG. 4 is a view illustrating a state in which the drum unit is being inserted into the image forming apparatus;

FIG. 5 is a perspective view illustrating the entirety of the image forming apparatus;

FIG. 6 is a perspective view illustrating the entirety of the image forming apparatus;

FIG. 7 is a perspective view of the image forming apparatus when a cartridge cover is in an open state;

FIG. 8 is a perspective view illustrating that the drum unit or the developing unit is taken out;

FIG. 9 is a schematic perspective view of an optical print head included in the image forming apparatus;

FIGS. 10A to 10C are views illustrating a schematic configuration of a substrate, and FIGS. 10D and 10E are views illustrating a schematic configuration of a lens array;

FIGS. 11A to 11C are views illustrating a configuration of a cleaning rod according to Example 1;

FIG. 12 is a view illustrating a guide configuration of a cleaning rod according to Example 1;

FIG. 13 is a view illustrating the guide configuration of the cleaning rod according to Example 1;

FIG. 14 is a rear view of a guide member of the cleaning rod according to Example 1;

FIG. 15 is a cross-sectional view of the guide member of the cleaning rod according to Example 1;

FIG. 16 is a cross-sectional view of the guide member of the cleaning rod according to Example 1;

FIG. 17 is a simplified cross-sectional view of the guide member of the cleaning rod according to Example 1;

FIG. 18 is a view illustrating a positional relationship between the cleaning rod and the optical print head according to Example 1;

FIG. 19 is a view illustrating the positional relationship between the cleaning rod and the optical print head according to Example 1;

FIG. 20 is a simplified cross-sectional view of the guide member of the cleaning rod according to Example 1;

FIG. 21 is a view illustrating a shape of the cleaning rod according to Example 1; and

FIG. 22 is a view illustrating a shape of the cleaning rod according to Example 1.

### DESCRIPTION OF THE EMBODIMENTS

Hereinafter, exemplary embodiments of the present disclosure will be described in detail with reference to the drawings. Constituent elements described in the following embodiments are merely examples, and the scope of the present disclosure is not intended to be limited only thereto.

### Example 1

### (Image Forming Apparatus)

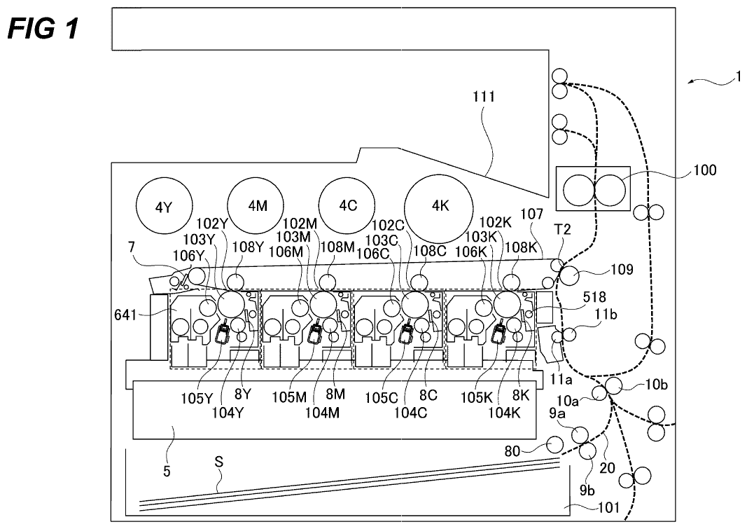

First, a schematic configuration of an image forming apparatus 1 will be described. FIG. 1 is a schematic cross-sectional view of the image forming apparatus 1. Although the image forming apparatus 1 illustrated in FIG. 1 is a color printer (multi function printer (MFP)) including a reading device, the embodiment may be another image forming apparatus such as a printer that does not include the reading device. The embodiment is not limited to a so-called tandem type color image forming apparatus including a plurality of photosensitive drums 103 as illustrated in FIG. 1, and may be a color image forming apparatus including one photosensitive drum 103 or an image forming apparatus that forms a monochrome image.

The image forming apparatus 1 illustrated in FIG. 1 includes four image forming portions 102Y, 102M, 102C, and 102K (also collectively and simply referred to as an “image forming portion 102” below) that form toner images of respective colors of yellow, magenta, cyan, and black.

The image forming portions 102Y, 102M, 102C, and 102K include photosensitive drums (photosensitive members) 103Y, 103M, 103C, and 103K (also collectively and simply referred to as a “photosensitive drum 103” below), respectively. These photosensitive drums are arranged apart from each other.

The image forming portions 102Y, 102M, 102C, and 102K include chargers 104Y, 104M, 104C, and 104K (also collectively and simply referred to as a “charger 104” below) that respectively charge the photosensitive drums 103Y, 103M, 103C, and 103K.

The image forming portions 102Y, 102M, 102C, and 102K include optical print heads 105Y, 105M, 105C, and 105K (also collectively and simply referred to as an “optical print head 105” below) that expose the photosensitive drums 103Y, 103M, 103C, and 103K, respectively.

Further, the image forming portions 102Y, 102M, 102C, and 102K include development devices 106Y, 106M, 106C, and 106K (also collectively and simply referred to as a “development device 106” below) that develop an electrostatic latent image on the photosensitive drum 103 with toner and develop a toner image of each color on the photosensitive drum 103. Y, M, C, and K attached to the reference numerals indicate the colors of the toner.

The image forming apparatus 1 illustrated in FIG. 1 is an image forming apparatus that adopts a so-called “lower surface exposure system” in which the photosensitive drum 103 is exposed from below, that is, the optical print head is disposed below the photosensitive drum 103. A description will be made below on the premise of an image forming apparatus adopting a lower surface exposure system. Although not illustrated, as an embodiment, an image forming apparatus adopting an “upper surface exposure system” that exposes the photosensitive drum from above may be used.

The image forming apparatus 1 includes an intermediate transfer belt 107 to which a toner image formed on the photosensitive drum 103 is transferred, and a primary transfer roller 108 (Y, M, C, and K) that sequentially transfers the toner image formed on the photosensitive drum 103 to the intermediate transfer belt. The intermediate transfer belt 107 is disposed above the image forming portion 102. In addition to an intermediate transfer method using the intermediate transfer belt 107, a direct transfer method of performing direct transfer from the photosensitive drum 103 to a recording material may be used.

The image forming apparatus 1 includes a secondary transfer roller 109 that transfers the toner image on the intermediate transfer belt 107 to a recording material S conveyed from a sheet feeding portion 101, and a fixing device 100 that fixes the secondarily transferred image to the recording material S.

Toners remain on the surfaces of the photosensitive drums 103Y, 103M, 103C, and 103K after the primary transfer. These residual toners are removed by drum cleaning devices 8Y, 8M, 8C, and 8K (also collectively and simply referred to as a “drum cleaning device 8” below), and are collected in a collection toner container 5.

The toner remains on the surface of the intermediate transfer belt 107 after the secondary transfer. The residual toner is removed by a belt cleaning device 7 and collected in the collection toner container 5.

### (Image Forming Process)

Next, an image forming process of the image forming apparatus 1 will be briefly described. The charger 104Y charges the surface of the photosensitive drum 103Y. The optical print head 105Y exposes the surface of the photosensitive drum 103Y charged by the charger 104Y. As a result, an electrostatic latent image is formed on the photosensitive drum 103Y. Then, the development device 106Y develops the electrostatic latent image formed on the photosensitive drum 103Y with yellow toner. A yellow toner image developed on the surface of the photosensitive drum 103Y is transferred onto the intermediate transfer belt 107 by the primary transfer roller 108Y. Magenta, cyan, and black toner images are also transferred to the intermediate transfer belt 107 in a similar image forming process.

The toner image of each color, which has been transferred onto the intermediate transfer belt 107, is conveyed to a secondary transfer portion T2 by the intermediate transfer belt 107. A transfer bias for transferring the toner image to the recording material S is applied to a secondary transfer roller 109 disposed in the secondary transfer portion T2. The toner image conveyed to the secondary transfer portion T2 is transferred to the recording material S conveyed from the sheet feeding portion (sheet feeding cassette) 101 by the transfer bias of the secondary transfer roller 109.

The recording material S is stored in a form of being stacked in the sheet feeding portion 101, and is fed to a conveyance path 20 according to an image forming timing. In a sheet feeding method, first, the leading end of a recording material S is flipped up by friction of a sheet feeding roller 80, and only one sheet of the recording material S is conveyed to the conveyance path 20 by a pair of conveying rollers 9a and 9b for separation for preventing double feeding of the recording material S. Thereafter, the recording material S pulled out by a pair of conveying rollers 10a and 10b passes through the conveyance path 20 and is conveyed to a pair of registration rollers 11a and 11b, and then is temporarily stopped. The recording material S is conveyed to the secondary transfer portion T2 after skew feeding correction and timing correction are performed by the pair of registration rollers 11a and 11b.

The recording material S to which the toner image has been transferred in the secondary transfer portion T2 is conveyed to the fixing device 100. The fixing device 100 fixes the toner image on the recording material S by heat and pressure. The recording material S subjected to a fixing process by the fixing device 100 is ejected to a sheet ejection portion 111.

As illustrated in FIG. 1, the image forming apparatus 1 includes toner containers 4Y, 4M, 4C, and 4K (also collectively and simply referred to as a “toner container 4” below). By performing image formation, the toner amount in a developing unit 641 (described later) decreases. At this time, the toner is supplied from the toner containers 4Y, 4M, 4C, and 4K provided corresponding to the image forming portions 102Y, 102M, 102C, and 102K to the developing unit 641 via pipes (not illustrated). That is, in the developing unit 641 included in the image forming apparatus 1 according to the present example, while new toner is replenished from the toner container 4, a part of excessive toner is conveyed to the collection toner container 5 as residual toner.

### (Drum Unit and Developing Unit)

A drum unit 518 that is an example of a replaceable replacement unit is attached to the image forming apparatus 1 in the present example. The drum unit 518 is a cartridge to be replaced by a worker such as a user or a maintenance person. The drum unit 518 (Y, M, C, and K) in the present example includes the photosensitive drum 103 (Y, M, C, and K) rotatably supported with respect to a frame body of the drum unit 518.

The developing unit 641 separate from the drum unit 518 is attached to the image forming apparatus 1 in the present example. The developing unit 641 in the present example is a cartridge in which the development device 106 illustrated in FIG. 1 and a toner accommodation portion are integrated. The development device 106 includes a developing sleeve that is a developer carrying member that carries a developer. The developing unit 641 is provided with a plurality of gears for rotating screws for stirring the toner and the carrier. When these gears deteriorate over time or the like, a worker detaches the developing unit 641 from the apparatus body of the image forming apparatus 1 and replaces the developing unit 641. A predetermined amount of toner is removed as residual toner from the developing unit 641, and is conveyed to the collection toner container 5. The embodiment of the drum unit 518 and the developing unit 641 may be a process cartridge in which the drum unit 518 and the developing unit 641 are integrated.

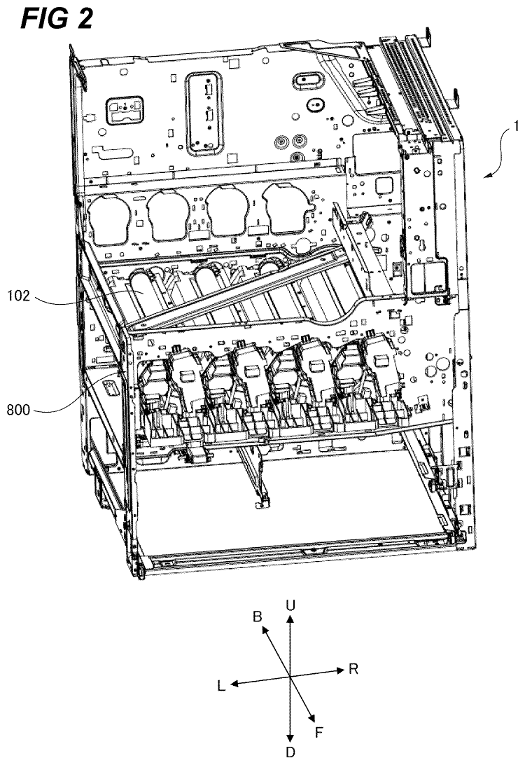

FIG. 2 is a perspective view of the image forming apparatus 1 in which only peripheral components of the image forming portion 102 and a frame body portion that supports the peripheral components are extracted.

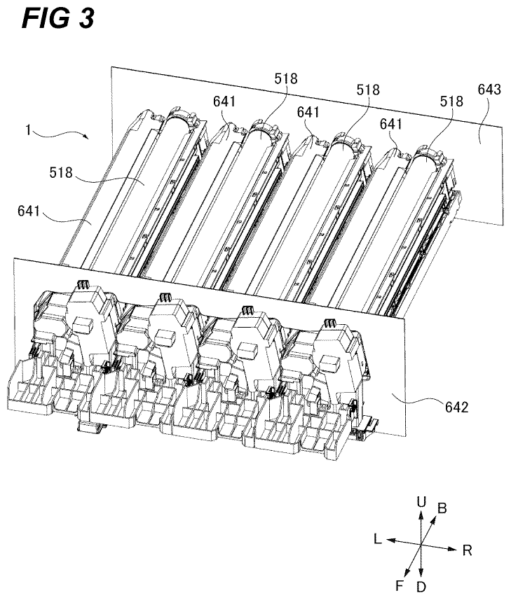

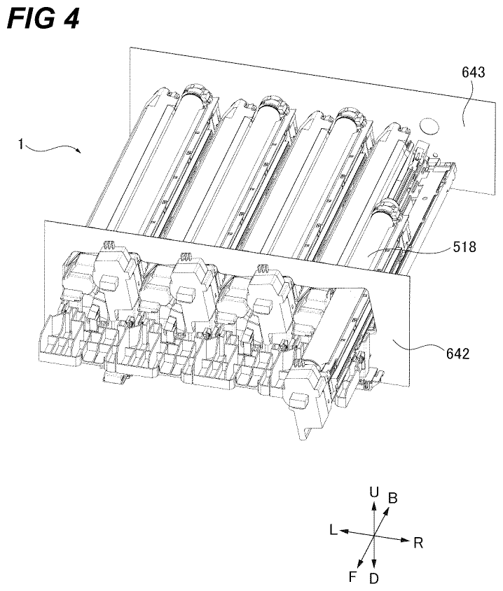

FIG. 3 is an enlarged perspective view of the image forming portion 102 in FIG. 2. FIG. 3 illustrates the drum unit 518 and the developing unit 641 included in the image forming apparatus 1. FIG. 4 is a view illustrating a state in which the drum unit 518 is being inserted into the image forming apparatus 1 from the outside of the apparatus body.

As illustrated in FIG. 3, the image forming apparatus 1 includes a front plate 642 formed of a sheet metal and a rear plate 643 similarly formed of a sheet metal. The front plate 642 is a side wall provided on the front side of the image forming apparatus 1. The rear plate 643 is a side wall provided on the rear side of the image forming apparatus 1. As illustrated in FIG. 3, the front plate 642 and the rear plate 643 are disposed to face each other, and a sheet metal (not illustrated) as a beam is bridged between the front plate and the rear plate. Each of the front plate 642, the rear plate 643, and a beam (not illustrated) constitutes a part of a frame body 800 of the image forming apparatus 1 (see FIG. 2).

An opening is formed in the front plate 642 such that the drum unit 518 and the developing unit 641 can be inserted and removed from the front side of the image forming apparatus 1. The drum unit 518 and the developing unit 641 are mounted at predetermined positions of the body of the image forming apparatus 1 via the opening (mounting position).

Next, a method of inserting and removing the drum unit 518 and the developing unit 641, which are components that need to be periodically replaced, from the image forming apparatus 1 will be described in more detail.

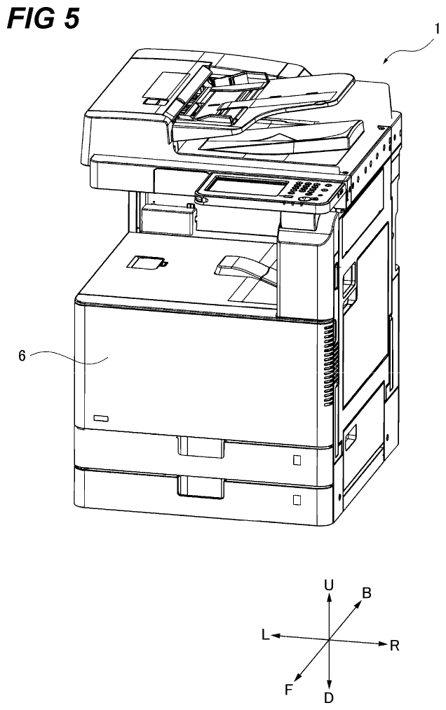

FIG. 5 is a perspective view illustrating the entirety of the image forming apparatus 1. A front cover 6 is provided on a front side surface of the body of the image forming apparatus 1. A worker such as a user or a service person opens the front cover 6 at time of maintenance and starts work.

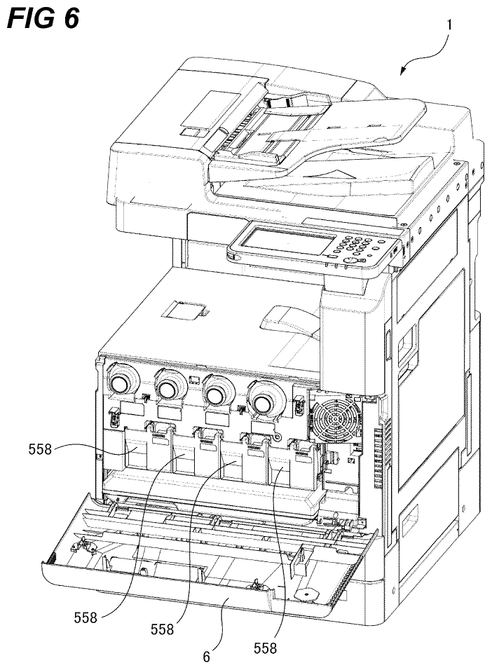

FIG. 6 is a perspective view of the image forming apparatus 1 when the front cover 6 is in an open state. The image forming apparatus 1 includes a cartridge cover 558 (Y, M, C, and K) that covers the front sides of both the drum unit 518 and the developing unit 641 mounted at the mounting positions. One end of the cartridge cover 558 is fixed to the body of the image forming apparatus 1 by a hinge, and is rotatable with respect to the body of the image forming apparatus 1 by the hinge.

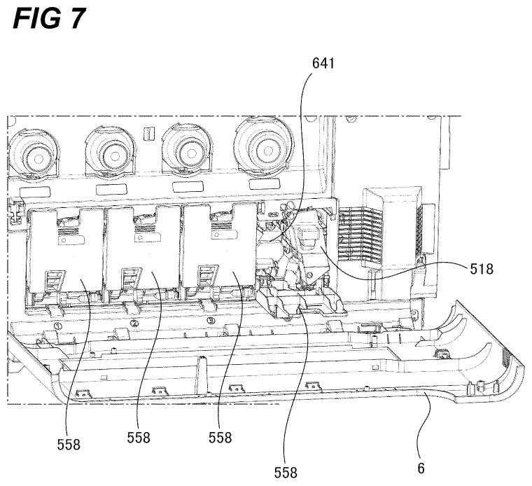

FIG. 7 is a perspective view of the image forming apparatus 1 when the cartridge cover 558 is further opened from the state illustrated in FIG. 6. A worker who performs maintenance opens the cartridge cover 558 and takes out the drum unit 518 or the developing unit 641 in the body.

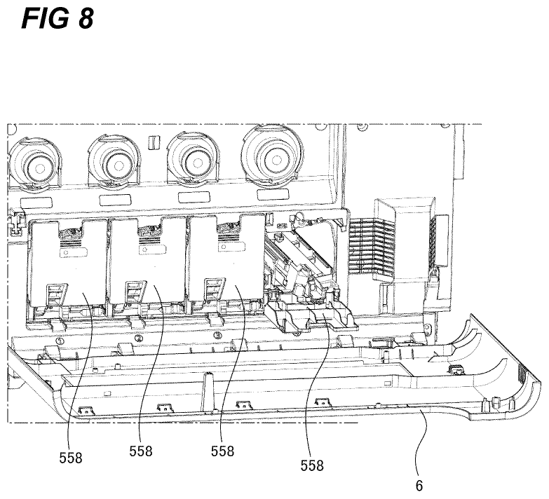

FIG. 8 is a perspective view illustrating a state in which the drum unit 518 and the developing unit 641 are taken out from the state illustrated in FIG. 7. From this state, replacement work is completed by inserting a new drum unit 518 or a new developing unit 641 and closing the cartridge cover 558.

In the following description, the front plate 642 side is defined as a front side, and the rear plate 643 side is defined as a rear side. When the photosensitive drum 103K on which an electrostatic latent image related to a black toner image is formed is used as a reference, a side on which the photosensitive drum 103Y on which an electrostatic latent image related to a yellow toner image is formed is disposed is defined as a left side. When the photosensitive drum 103Y on which an electrostatic latent image related to a yellow toner image is formed is used as the reference, a side on which the photosensitive drum 103K on which an electrostatic latent image related to a black toner image is formed is disposed is defined as a right side. Furthermore, a direction that is perpendicular to a front-back direction and a right-left direction defined here and is upward in the vertical direction is defined as an upward direction, and a direction that is perpendicular to the front-back direction and the right-left direction defined here and is downward in the vertical direction is defined as a downward direction. The defined forward direction F, rearward direction B, rightward direction R, leftward direction L, upward direction U, and downward direction D are shown in FIGS. 2, 3, and 5.

One end side in a rotational axis direction of the photosensitive drum 103 described below means a front side defined herein, and the other end side means a rear side defined herein. One end side and the other end side in the front-back direction also correspond to the front side and the rear side defined here. One end side in the right-left direction means the right side defined here, and the other end side means the left side defined here.

Here, in the present embodiment, the toner (developer) accommodated in the toner container (developing container) is a two-component developer in which a negatively charged nonmagnetic toner and a magnetic carrier are mixed. The nonmagnetic toner contains a colorant, a wax component, or the like in resin such as polyester or styrene, and is pulverized or polymerized to form a powder. In the present embodiment, particles having an average particle diameter of 5 μm were used. The magnetic carrier is obtained by applying resin coating to a surface layer of a core made of resin particles obtained by kneading ferrite particles and magnetic powder.

### (Basic Configuration of Optical Print Head)

Next, the optical print head (exposure head) 105 will be described. Here, as an example of an exposure system adopted in an image forming apparatus of an electrophotographic system, there is a laser beam scanning exposure system in which an irradiation beam of a semiconductor laser is scanned with a rotating polygon mirror or the like, and the photosensitive drum is exposed through an f-θ lens or the like. The “optical print head 105” described in the present example is used for an LED exposure system that exposes the photosensitive drum 103 by using light emitting elements such as LEDs arranged along the rotational axis direction of the photosensitive drum 103, and is not used for the laser beam scanning exposure system described above.

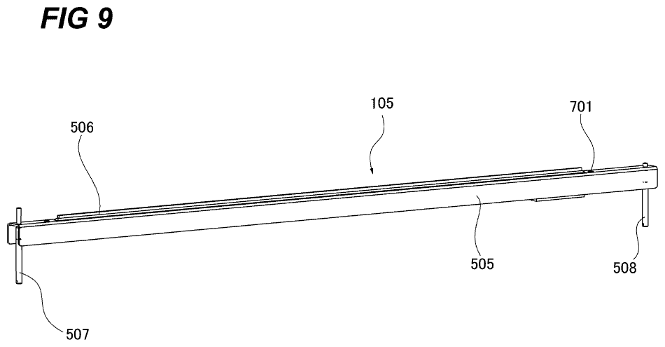

The optical print head 105 described in the present example is provided below the rotational axis of the photosensitive drum 103 in the vertical direction, and exposes the photosensitive drum 103 from below by a light beam emitted from an LED 503 of the optical print head 105. FIG. 9 is a schematic perspective view of the optical print head 105 included in the image forming apparatus 1 in the present example.

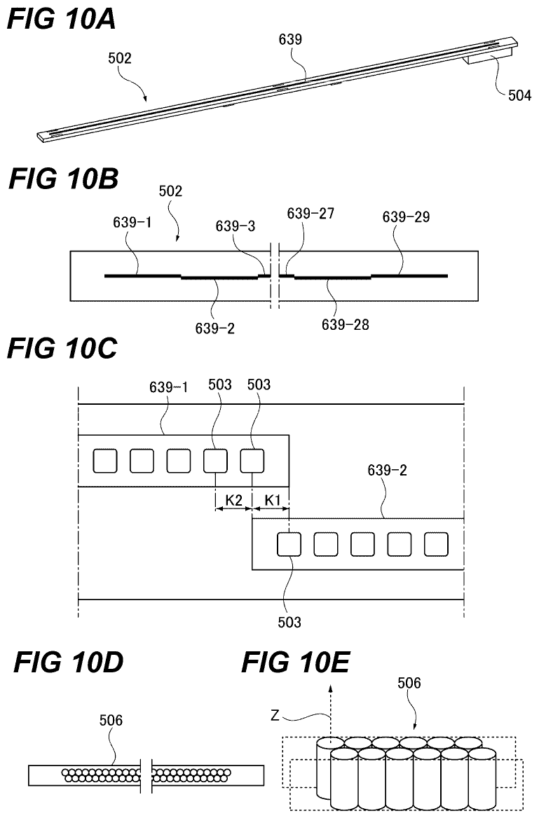

As illustrated in FIG. 9, the optical print head (exposure head) 105 has an elongated shape (longitudinal shape) extending in the rotational axis direction of the photosensitive drum 103. The optical print head 105 includes a substrate 502, a light emitting element mounted on the substrate 502, a lens array 506, and a holding member 505 that holds the substrate 502 and the lens array 506. Here, the optical print head 105 includes the light emitting diode (LED) 503 as the light emitting element that emits light (see FIG. 10C). The substrate 502 is installed inside the holding member 505. The holding member 505 is provided with a lens attachment portion 701 for attaching the lens array 506.

Next, the substrate 502 held by the holding member 505 will be described. FIG. 10A is a schematic perspective view of the substrate 502. FIG. 10B illustrates an arrangement of a plurality of LEDs 503 provided on the substrate 502, on the substrate 502. FIG. 10C is an enlarged view of FIG. 10B.

An LED chip 639 is mounted on the substrate 502. As illustrated in FIG. 10A, the LED chip 639 is provided on one surface of the substrate 502, and a long FFC connector 504 is provided on the other surface (surface opposite to the surface on which the light emitting elements are arranged). The FFC connector 504 is attached to the lower surface of the substrate 502 such that the longitudinal direction of the FFC connector 504 is along the longitudinal direction of the substrate 502. Wiring for supplying a signal to each LED chip 639 is provided on the substrate 502. One end of a flexible flat cable (not illustrated, referred to as an FFC below) as an example of a cable is connected to the FFC connector 504.

The body of the image forming apparatus 1 is provided with a substrate (not illustrated) including a controller and a connector. The other end of the FFC is connected to this connector. That is, the FFC electrically connects the substrate of the body of the image forming apparatus 1 and the substrate 502 of the optical print head 105. A control signal (drive signal) is input to the substrate 502 from the controller of the body of the image forming apparatus 1 via the FFC and the FFC connector 504. The LED chip 639 is driven by a control signal input to the substrate 502.

The LED chip 639 mounted on the substrate 502 will be described in more detail. As illustrated in FIGS. 10B and 10C, a plurality of LED chips 639-1 to 639-29 (29 pieces) in which a plurality of LEDs 503 (an example of the light emitting element) is disposed is arranged on one surface of the substrate 502. In each of the LED chips 639-1 to 639-29, 516 LEDs 503 are arranged in a row in the longitudinal direction thereof. In the longitudinal direction of the LED chip 639, a center-to-center distance k2 between the adjacent LEDs 503 corresponds to the resolution of the image forming apparatus 1. Since the resolution of the image forming apparatus 1 in the present example is 1200 dpi, the LEDs 503 are arranged in a row such that the center-to-center distance k2 between the adjacent LEDs 503 is 21.16 μm in the longitudinal direction of the LED chips 639-1 to 639-29. Therefore, an exposure range of the optical print head 105 in the present example is about 314 mm. A photosensitive layer of the photosensitive drum 103 is formed to have a width of 314 mm or more. Since the length of the long side of an A4-size recording sheet and the length of the short side of an A3-size recording sheet are 297 mm, the optical print head 105 in the present example has an exposure range in which an image can be formed on the A4-size recording sheet and the A3-size recording sheet.

The LED chips 639-1 to 639-29 are alternately arranged in two rows along the rotational axis direction of the photosensitive drum 103. That is, as illustrated in FIG. 10B, the odd-numbered LED chips 639-1, 639-3, . . . , 639-29 counted from the left side are mounted in a row in the longitudinal direction of the substrate 502. Further, the even-numbered LED chips 639-2, 639-4, . . . , 639-28 counted from the left side are mounted in a row in the longitudinal direction of the substrate 502. By arranging the LED chip 639 as described above, as illustrated in FIG. 10C, in the longitudinal direction of the LED chip 639, a center-to-center distance k1 between the LEDs 503 disposed at one end of one LED chip 639 and the other end of the other LED chip 639 among the different adjacent LED chips 639 can be made equal to the center-to-center distance k2 between the adjacent LEDs 503 on one LED chip 639.

In the present example, the light emitting element (exposure light source) is a semiconductor LED that is a light emitting diode, and may be, for example, an organic light emitting diode (OLED). This OLED is also called organic electro-luminescence (EL), and is a current-driven light emitting element. OLEDs are arranged on a line along the main scanning direction (axis direction of the photosensitive drum 103) on a thin film transistor (TFT) substrate, for example, and are electrically connected in parallel by power supply wiring similarly provided along the main scanning direction.

Next, the lens array 506 that is a lens assembly will be described. FIG. 10D is a schematic view of the lens array 506 as viewed from the photosensitive drum 103 side. FIG. 10E is a schematic perspective view of the lens array 506. As illustrated in FIG. 10D, the lens array 506 condenses light emitted from the light emitting element on the photosensitive drum 103. The lens array 506 is a lens assembly including a plurality of lenses. The plurality of lenses is arranged in two rows along the arrangement direction of the plurality of LEDs 503. The lenses are alternately arranged such that one of the lenses in the other row is arranged to be in contact with both of the adjacent lenses in an arrangement direction of the lenses in one row. Each lens is a cylindrical rod lens made of glass. Each lens has a light incident surface on which light emitted from the LED 503 is incident and a light emitting surface from which the light incident from the light incident surface is emitted. The material of the lens is not limited to glass, and may be plastic. The shape of the lens is not limited to the cylindrical shape, and may be, for example, a polygonal prism such as a hexagonal prism.

A dotted line Z illustrated in FIG. 10E indicates the optical axis of the lens. The optical print head 105 is movable in a direction substantially along the optical axis of the lens (also referred to as an optical axial direction below) indicated by a dotted line Z by a moving mechanism (not illustrated). The optical axis of the lens here means a line linking the center of the light emitting surface of the lens and the focal point of the lens. The lens array 506 is a lens assembly having a plurality of lenses, and the “optical axis” described above is an optical axis of any lens among the plurality of lenses. Here, strictly speaking, the plurality of lenses included in the lens array 506 may be slightly inclined to each other. This is due to tolerance during assembly. However, the deviation of the tolerance is not considered in a case where the direction of the optical axis is defined. Therefore, it is considered that the optical axis of the plurality of lenses is in the same direction. The lens array 506 has a function of condensing the light emitted from the LED 503 on the surface of the photosensitive drum 103. That is, radiation light emitted from the LED 503 is incident on the lens included in the lens array 506. The lens has a function of condensing the incident radiation light on the surface of the photosensitive drum 103.

The mounting position of the lens array 506 with respect to the lens attachment portion 701 (see FIG. 9) is adjusted at the time of assembling the optical print head 105 such that a distance between the light emitting surface of the LED 503 and the light incident surface of the lens is substantially equal to a distance between the light emitting surface of the lens and the surface of the photosensitive drum 103.

Inside the image forming apparatus, the optical print head 105 is provided to be movable between an exposure position where the photosensitive drum 103 is exposed and a retraction position farther away from the photosensitive drum 103 than the exposure position. The optical print head 105 exposes the photosensitive drum 103 at the exposure position. The optical print head 105 is moved between the exposure position and the retraction position by a moving mechanism (not illustrated).

The holding member 505 of the optical print head 105 is provided with a positioning pin 507 and a positioning pin 508. The positioning pin 507 is provided on one side of the holding member 505 (an end portion on the front side of the lens array 506) in the rotational axis direction of the photosensitive drum 103. The positioning pin 508 is provided on the other side of the holding member 505 (an end portion on the rear side of the lens array 506) in the rotational axis direction of the photosensitive drum 103.

The positioning pins 507 and 508 protrude from both sides of the holding member 505 in the optical axial direction of the lens array 506. When the positioning pin 507 and the positioning pin 508 are caused to abut on the drum unit 518, a gap is formed between the lens array 506 and the photosensitive drum 103. In this manner, the position (exposure position) of the optical print head 105 with respect to the photosensitive drum 103 is determined.

### (Cleaning Rod and Guide Member)

In the image forming apparatus 1, the optical print head (exposure head) 105 is provided between the charger 104 and the development device 106. When foreign matters such as toner adhere to the light emitting surface of the lens array 506 included in the optical print head 105, light emitted from the light emitting element may be partially shielded, which causes deterioration in image quality of an output image. Therefore, it is desirable that the light emitting surface of the optical print head 105 is periodically cleaned.

The image forming apparatus 1 includes a cleaning rod 801 that has a longitudinal shape, is inserted from the outside of the image forming apparatus 1, and cleans the surface (light emitting surface) of the lens array 506 of the optical print head 105 by rubbing the surface of the lens array 506 in the longitudinal direction. In addition, the image forming apparatus 1 includes a guide member 808 that guides the cleaning rod 801 inserted from the outside of the image forming apparatus 1 in the longitudinal direction while abutting on the surface (light emitting surface) of the lens array 506. Configurations of the cleaning rod 801 and the guide member 808 will be described below in order.

### (Configuration of Cleaning Rod)

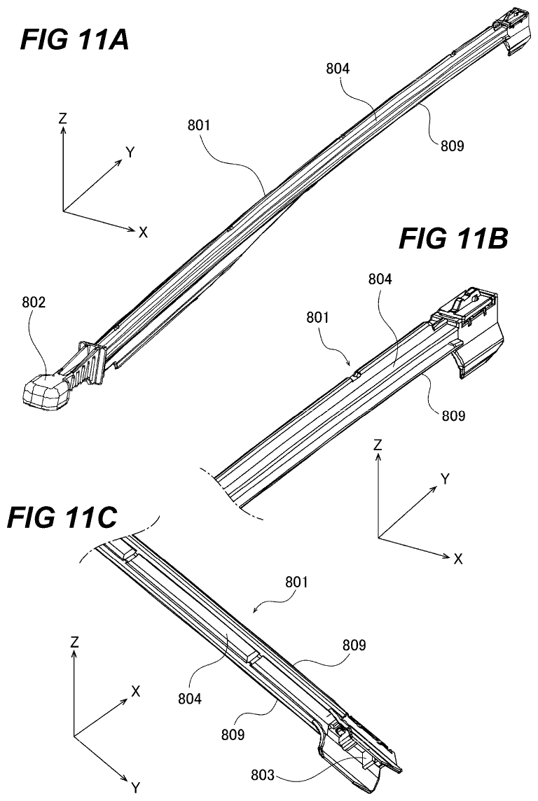

A configuration of the cleaning rod 801 will be described with reference to FIGS. 11A to 11C.

FIG. 11A is a schematic perspective view of the cleaning rod 801 that cleans the surface (light emitting surface) of the lens array 506 of the optical print head 105. FIG. 11B is a view illustrating one end side (tip side) of the cleaning rod 801 in the longitudinal direction. FIG. 11C is a view of the tip side of the cleaning rod 801 as viewed from below.

Here, the longitudinal direction of the optical print head 105 is a direction along the rotational axis direction of the photosensitive drum 103, and is a direction parallel to the rotational axis direction. The front side in the longitudinal direction of the optical print head 105 means the front side in the front-back direction, and the back side in the longitudinal direction means the back side in the front-back direction. A width direction perpendicular to the longitudinal direction of the optical print head 105 is defined as a first direction. An optical axial direction perpendicular to both the longitudinal direction and the width direction (first direction) of the optical print head 105 is defined as a second direction. Further, the longitudinal direction of the optical print head 105 is defined as a third direction. FIGS. 11A to 11C and the like illustrate defined longitudinal direction (third direction) Y, width direction (first direction) X, and optical axial direction (second direction) Z.

The cleaning rod 801 cleans the lens array 506 of the optical print head 105. The cleaning rod 801 includes a grip portion 802 at one end (rear end) of a body portion 804 having an elongated rod shape as a whole, and includes a cleaning portion 803 at the other end (front end). The cleaning rod 801 has a shape extending in the longitudinal direction along the rotational axis direction of the photosensitive drum 103.

The cleaning portion 803, the grip portion 802, and the body portion 804 are illustrated as an integral body, but may be configured as separate bodies that are detachably attachable. In addition, the cleaning rod 801 may be provided in, for example, a cover member (not illustrated) in the image forming apparatus, but may be prepared outside the image forming apparatus and used in a case where cleaning is required.

The grip portion 802 is provided at one end (rear end) of the body portion 804 of the cleaning rod 801, and is gripped by a worker during cleaning work.

The cleaning portion 803 is provided at the other end (tip) of the body portion 804 of the cleaning rod 801. The cleaning portion 803 is provided on the lower side of the cleaning rod 801 in the optical axial direction Z, and protrudes in a direction (lower side) approaching the optical print head 105 in the optical axial direction Z. A pressing member (not illustrated) for fixing the cleaning portion 803 is provided on the tip side of the cleaning rod 801.

The cleaning rod 801 further includes a restriction target portion 809 that abuts on a restricting portion of the guide member 808 to restrict the movement in the optical axial direction Z. The restriction target portion 809 will be described later in detail.

### (Configuration of Guide Member)

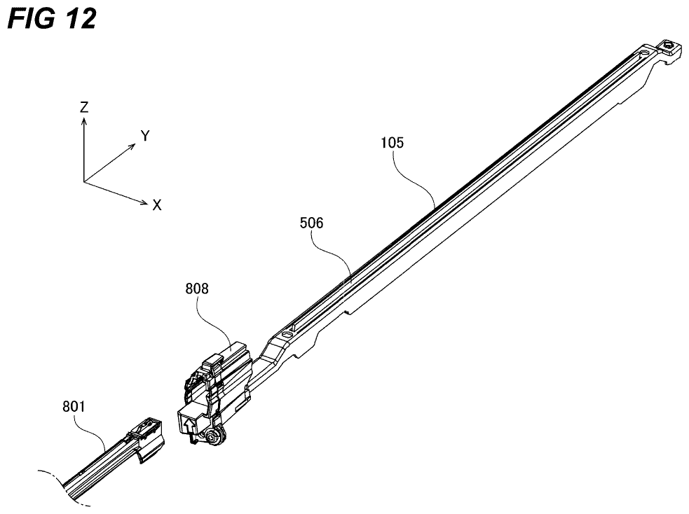

Next, the configuration of the guide member 808 will be described with reference to FIGS. 12, 14, and 15.

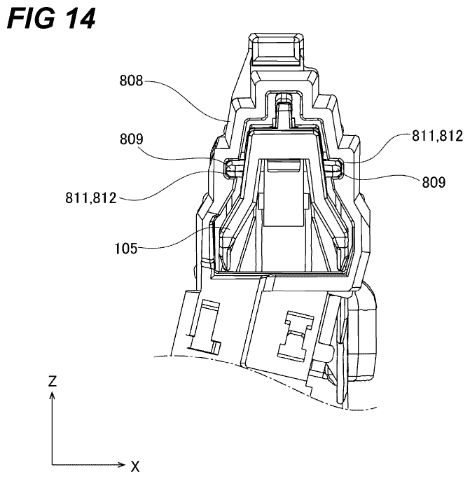

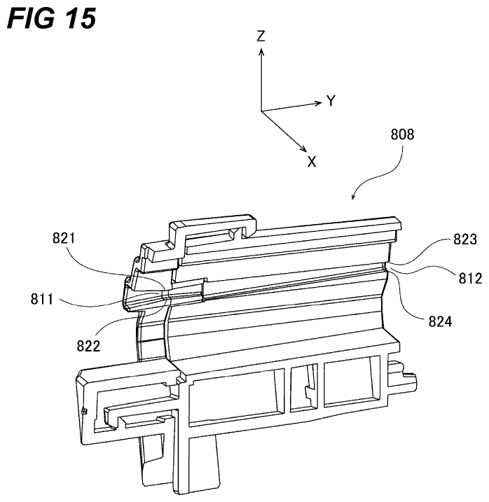

FIG. 12 is a view illustrating a configuration of the guide member. FIG. 14 is a rear view of the guide member. FIG. 15 is a cross-sectional view of the guide member.

The image forming apparatus 1 includes the frame body 800 (see FIG. 2) as a housing, and the frame body 800 is provided with the guide member 808 as illustrated in FIG. 12. The optical print head 105 is disposed on the apparatus back side with respect to the guide member 808, and the guide member 808 is configured to guide the cleaning rod 801 inserted from the apparatus front side to the optical print head 105. In other words, the guide member 808 is provided on the front side of the optical print head 105 in the insertion direction of the cleaning rod 801 on an extension line in the longitudinal direction of the lens array 506.

As illustrated in FIG. 15, the guide member 808 includes restricting portions 821 and 823 that restrict movement of the cleaning rod 801 in a direction away from the optical print head 105, and restricting portions 822 and 824 that restrict movement of the cleaning rod 801 in a direction approaching the optical print head.

The restricting portions 821, 822, 823, and 824 of the guide member 808 have the following positional relationship.

The restricting portion 823 is a first restricting portion that restricts the movement of the cleaning rod 801 abutting on the lens array 506 in the direction away from the optical print head 105.

The restricting portion 822 is a second restricting portion that restricts the movement of the cleaning rod 801 abutting on the restricting portion 823 in the direction approaching the optical print head 105. The restricting portion 822 is provided on the upstream side of the restricting portion 823 in the insertion direction of the cleaning rod 801.

The restricting portion 821 is a third restricting portion that restricts the movement of the cleaning rod 801 in the direction away from the optical print head 105. The restricting portion 821 is provided on the upstream side of the restricting portion 823 in the insertion direction, and is provided above the restricting portion 823 in the optical axial direction Z. The restricting portion 821 is provided at a position facing the restricting portion 821 in the optical axial direction Z.

The restricting portion 824 is a fourth restricting portion that restricts the movement of the cleaning rod 801 in the direction approaching the optical print head 105. The restricting portion 824 is provided on the downstream side of the restricting portion 822 in the insertion direction, and is provided below the restricting portion 822 in the optical axial direction Z. The restricting portion 824 is provided at a position facing the restricting portion 823 in the optical axial direction Z.

### (Cleaning Operation)

Next, an actual operation during cleaning will be described.

Cleaning of the light emitting surface of the lens array 506 using the cleaning rod 801 is performed in a state where the optical print head 105 is moved to the retraction position where the optical print head 105 is retracted from the photosensitive drum 103 by a moving mechanism (not illustrated). That is, the retraction position mentioned here means a cleaning position for cleaning the light emitting surface of the lens array 506. A worker grips the grip portion 802 provided on the rear end side of the cleaning rod 801 and operates the cleaning rod 801 in the longitudinal direction that is the axis direction of the photosensitive drum 103, thereby cleaning the light emitting surface of the lens array 506.

As illustrated in FIG. 11C, the cleaning portion 803 is provided on the tip side in the insertion direction of the cleaning rod 801 (the other end side in the rotational axis direction of the photosensitive drum 103) and on the lower side in the optical axial direction Z. The cleaning portion 803 is, for example, an elastically deformable member made of rubber such as sponge or elastomer, and performs cleaning by scraping off dirt such as toner falling on the light emitting surface of the lens array 506. The cleaning portion 803 is not limited to an elastically deformable member, and may be, for example, a nonwoven fabric made of fiber such as cotton, nylon, or polyester, or may be configured to perform cleaning by wiping off dirt such as toner falling on the light emitting surface of the lens array 506.

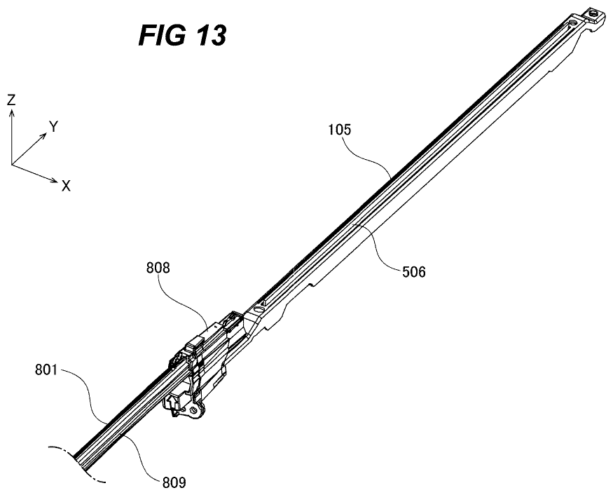

As illustrated in FIGS. 12 and 13, the guide member 808 is provided on the front side of the apparatus body in the longitudinal direction Y with respect to the optical print head 105. In a case where a guide portion is additionally provided in a region part of the optical print head 105 in the longitudinal direction Y, the configurations of the drum unit 518, the developing unit 641, and the like are in the vicinity, and thus there is a possibility a sufficient shape for the guide portion is not able to be disposed due to a space problem. Therefore, it is necessary to have a configuration in which the cleaning rod 801 is guided only at one position on the front side of the apparatus.

Therefore, the guide member 808 that guides the cleaning rod 801 inserted from the outside of the apparatus to the optical print head 105 is provided on the front side of the optical print head 105 in the insertion direction of the cleaning rod 801 on the extension line in the longitudinal direction of the lens array 506 (see FIG. 12).

As illustrated in FIG. 13, the cleaning rod 801 is inserted into the guide member 808 from the outside of the image forming apparatus 1, and is guided in the longitudinal direction Y toward the optical print head 105 by the guide member 808.

As illustrated in FIG. 15, the guide member 808 includes a first guide portion 811 and a second guide portion 812. The first guide portion 811 and the second guide portion 812 are arranged side by side along the longitudinal direction Y and are arranged apart from each other in the longitudinal direction Y. In the guide member 808, the first guide portion 811 on the upstream side in the insertion direction is provided with the restricting portion 821 and the restricting portion 822, and the second guide portion 812 on the downstream side in the insertion direction is provided with the restricting portion 823 and the restricting portion 824.

As described above, the restricting portions 821 and 823 disposed apart from each other in the insertion direction restrict the movement of the cleaning rod 801 in the direction (upward direction) in which the cleaning rod 801 moves away from the optical print head 105 in the optical axial direction Z. On the other hand, the restricting portion 822 and the restricting portion 824 disposed away from each other in the insertion direction restrict the movement of the cleaning rod 801 in the direction (downward direction) in which the cleaning rod 801 approaches the optical print head 105 in the optical axial direction Z.

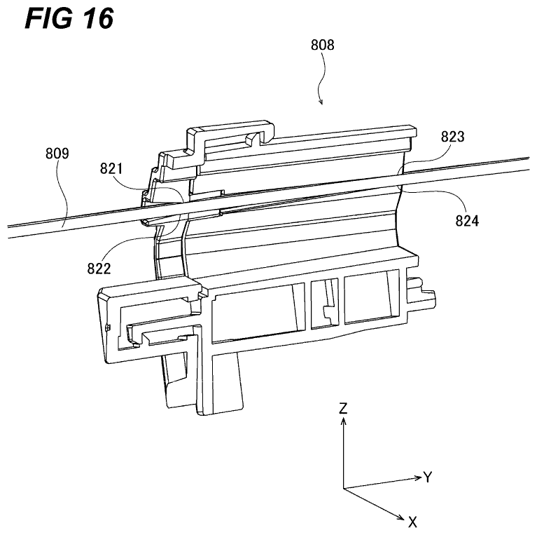

The cleaning rod 801 includes a restriction target portion 809 illustrated in FIGS. 14 and 16. FIG. 14 is a view of the guide member 808 as viewed from the front side to the back side of the apparatus in the longitudinal direction Y. The restriction target portion 809 of the cleaning rod 801 is provided at two places in total, one on each of the left and right sides in the width direction X perpendicular to the longitudinal direction Y and the optical axial direction Z. The restriction target portion 809 of the cleaning rod 801 is restricted by the restricting portions 821 and 823 and the restricting portions 822 and 824. Here, the restriction target portion 809 and the restricting portions 821, 822, 823, and 824 on one side (left side) of FIG. 14 will be described. The relationship between the restriction target portion 809 and the restricting portion 821, 822, 823, and 824 on the other side (right side) of FIG. 14 has the similar configuration except for the left-right symmetry, and thus description thereof will be omitted here.

The restriction target portion 809 of the cleaning rod 801 and the restricting portions 821, 822, 823, and 824 of the guide member 808 have the following relationship.

As illustrated in FIG. 13, the cleaning rod 801 is inserted into the guide member 808 from the outside of the image forming apparatus. Then, as illustrated in FIG. 16, the restriction target portion 809 of the cleaning rod 801 passes between the restricting portion 821 and the restricting portion 822 on the upstream side in the insertion direction, further passes between the restricting portion 823 and the restricting portion 824 on the downstream side in the insertion direction, and then is guided along the longitudinal direction of the optical print head 105.

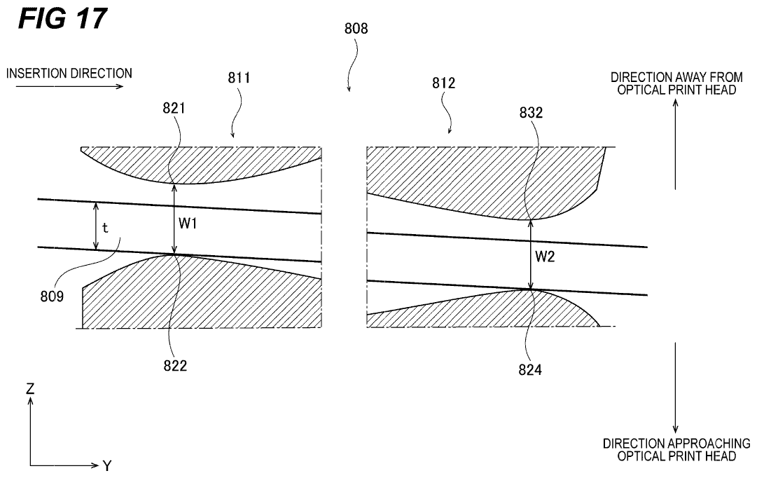

As illustrated in FIG. 17, the restriction target portion 809 has a rib shape having a thickness t. The thickness t of the restriction target portion 809 in the optical axial direction Z is set to be smaller than a second interval w1 between the restricting portion 821 and the restricting portion 822 in the optical axial direction Z and to be smaller than a third interval w2 between the restricting portion 823 and the restricting portion 824 in the optical axial direction Z. By providing a backlash between the restriction target portion and the restricting portion as described above, the restricting portion of the guide member 808 does not hinder the movement of the cleaning rod 801 in the longitudinal direction Y (insertion direction).

Next, the positional relationship between the restricting portion 821 and the restricting portion 823, and the restricting portion 822 and the restricting portion 824, and the optical print head 105 in the optical axial direction Z will be described with reference to FIG. 17.

The restricting portion 823 is located below the restricting portion 821 in the optical axial direction Z. Regarding the restriction target portion 809 of the cleaning rod 801, the movement of the cleaning rod 801 in the direction away from the optical print head 105 is restricted by the restricting portion 821 and the restricting portion 823. The movement of the cleaning rod 801 in the direction approaching the optical print head 105 is restricted by the restricting portion 822 and the restricting portion 824. That is, the cleaning rod 801 in which the restriction target portion 809 is restricted along a straight line linking the restricting portion 821 and the restricting portion 823 and a straight line linking the restricting portion 822 and the restricting portion 824 is guided to approach the optical print head 105 as it goes toward the apparatus back side in the insertion direction (longitudinal direction Y).

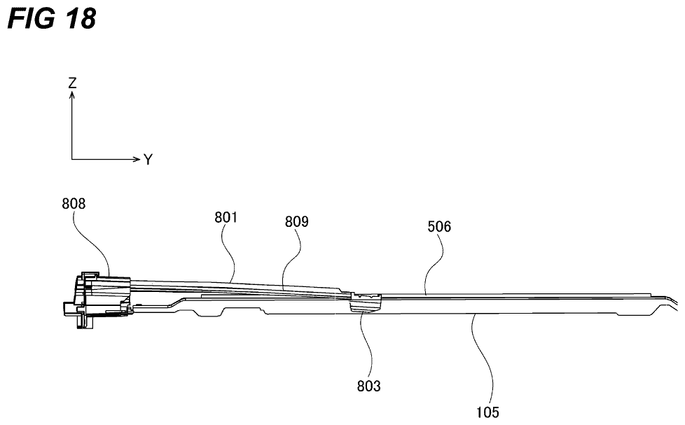

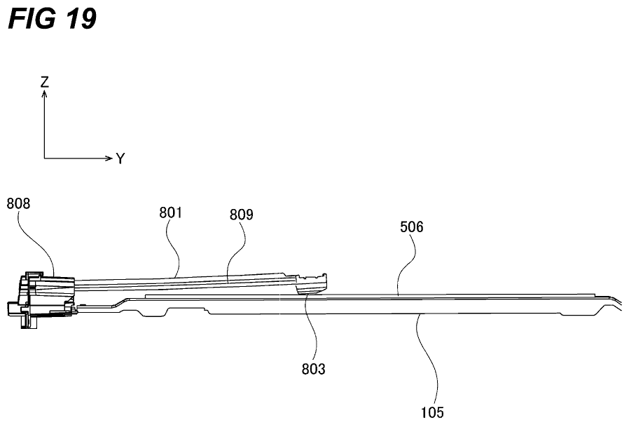

At this time, when the interference between the cleaning rod 801, and the cleaning portion 803 and the optical print head 105 is ignored, as illustrated in FIG. 18, the cleaning portion 803 provided at the tip of the cleaning rod 801 has a positional relationship of entering with respect to the optical print head 105 in the downward direction. However, in practice, as illustrated in FIG. 19, the cleaning rod 801 is curved downward, so that the cleaning portion 803 at the tip thereof abuts on the surface (emission surface) of the lens array 506 of the optical print head 105 with predetermined pressure. This positional relationship is normally maintained in the process in which the cleaning portion 803 abuts on the surface (emission surface) of the lens array 506 of the optical print head 105 in the process of inserting the cleaning rod 801 in the longitudinal direction Y.

That is, the restricting portion 823 on the downstream side of the restricting portion 821 in the insertion direction is disposed on the lower side of the restricting portion 821 in the optical axial direction, and the restricting portion 824 on the downstream side of the restricting portion 822 in the insertion direction is disposed on the lower side of the restricting portion 822 in the optical axial direction. Therefore, the restriction target portion 809 of the cleaning rod 801 passes between the restricting portion 821 and the restricting portion 822 on the upstream side in the insertion direction, further passes between the restricting portion 823 and the restricting portion 824 on the downstream side in the insertion direction, and then is guided in the direction approaching the optical print head 105. As a result, the cleaning portion 803 of the cleaning rod 801 is caused to abut on the surface of the lens array 506 of the optical print head 105.

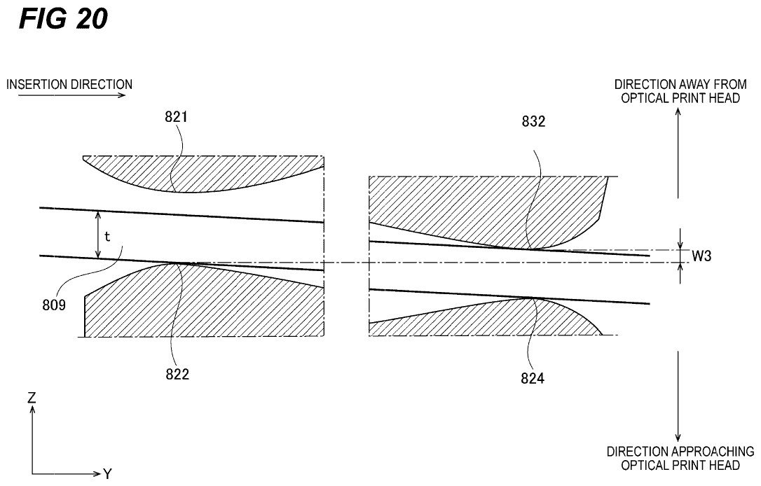

Next, a positional relationship between the restricting portion 822 and the restricting portion 823, and the optical print head 105 in the optical axial direction Z will be described with reference to FIG. 20.

As described above, there is a backlash between the restricting portions 821 and 822, and the restriction target portion 809 of the cleaning rod 801, and between the restricting portions 823 and 824, and the restriction target portion 809 of the cleaning rod 801. Therefore, for example, in a case where the cleaning rod 801 is pushed down in the direction approaching the optical print head 105 in the optical axial direction Z with the grip portion 802 held after the cleaning rod 801 is inserted into the guide member 808, the restriction target portion 809 of the cleaning rod 801 is inclined in the direction in which the cleaning portion 803 moves away from the optical print head 105. Thereafter, the movement of the restriction target portion 809 of the cleaning rod 801 is restricted by abutting on the restricting portion 822 and the restricting portion 823 as illustrated in FIG. 20, and the inclination of the cleaning rod 801 is determined. That is, the movement of the cleaning rod 801 in the direction away from the optical print head 105 is restricted by the restriction target portion 809 abutting on the restricting portion 823, and the movement of the cleaning rod 801 in the direction approaching the optical print head 105 is restricted by the restriction target portion 809 abutting on the restricting portion 822, and the inclination thereof is determined.

Here, the thickness t of the restriction target portion 809 in the optical axial direction Z is set to be larger than a first interval w3 between the restricting portion 822 and the restricting portion 823 in the optical axial direction Z. As a result, the cleaning rod 801 is guided in the direction approaching the optical print head 105. The cleaning portion 803 provided at the tip of the cleaning rod 801 is in a positional relationship of entering with respect to the optical print head 105 in the downward direction. Therefore, as illustrated in FIG. 19, the cleaning rod 801 is curved, so that the cleaning portion 803 can maintain an abutting state with the pressure on the surface of the lens array 506 of the optical print head 105.

As described above, as a result of the above-described dimensions and positional relationships between the restricting portions 821, 822, and 823, and the restriction target portion 809, the cleaning portion 803 can normally abut with certain pressure without moving away from the optical print head 105 in the insertion process of the cleaning rod 801. Therefore, it is possible to stably secure the cleaning ability of the optical print head 105, and it is possible to reliably clean the lens array surface of the optical print head 105. For example, even if the position of the grip portion 802 of the cleaning rod 801 operated by the worker is not stable in the optical axial direction, the cleaning rod 801 can normally abut on the optical print head 105.

### (Shape of Cleaning Rod)

Next, the shape of the cleaning rod 801 will be described. The cleanability can be sufficiently secured only by the size and positional relationship of the restricting portion of the guide member 808, the restriction target portion of the cleaning rod 801, and the optical print head 105 described above. However, by implementing the following configuration, a more stable cleaning effect can be obtained.

As illustrated in FIG. 19, in a case where the cleaning rod 801 is curved and abuts on the optical print head 105, an abutment force applied from the cleaning portion 803 to the optical print head 105 is equal to a force for curving the cleaning rod 801. For simplicity, the cleaning rod 801 is approximated as a cantilever beam. When the Young's modulus is set as E, the geometrical moment of inertia is set as I, and the deflection amount is set as δ, an abutment force P1 is expressed by the following Expression 1.

$${P}_{1} = \frac{3 EI δ}{{L}^{3}} \qquad ( Expression 1 )$$

A force required to curve the cleaning rod 801 having a length of a free length L is inversely proportional to the cube of the free length L. That is, as the cleaning rod 801 is inserted deeper, the force required to curve the cleaning rod 801 decreases in inverse proportion to the cube of the free length L.

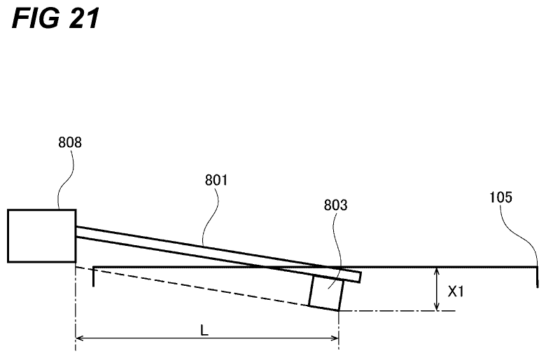

On the other hand, as illustrated in FIG. 21, the entering amount X1 into the optical print head 105 increases as the cleaning rod 801 is inserted toward the back side. The amount of increase in the entering amount X1 is proportional to the length of the free length L. Assuming that k is a coefficient, a relationship between the entering amount X1 and the free length L is expressed by the following Expression 2.

$$X = k L \qquad ( Expression 2 )$$

That is, the influence of the entering amount X with respect to the abutment force P1 of the cleaning portion 803 with respect to the optical print head 105 is a relationship in which the abutment force P1 increases in proportion to the entering amount X1. Here, since the entering amount X1 is equal to the deflection amount δ as a beam, the following Expression 3 is obtained by substituting the entering amount X1 of Expression 2 into the deflection amount δ of Expression 1.

$${P}_{1} = \frac{3 EIk}{{L}^{2}} \qquad ( Expression 3 )$$

From the above relationship, the abutment force by which the cleaning portion 803 at the tip of the cleaning rod 801 abuts on the optical print head 105 is inversely proportional to the square of the free length L in view of the influence of the free length L and the influence of the entering amount X1. That is, as the cleaning rod 801 is inserted deeper, the abutment force of the cleaning portion 803 decreases in inverse proportion to the square of the free length L.

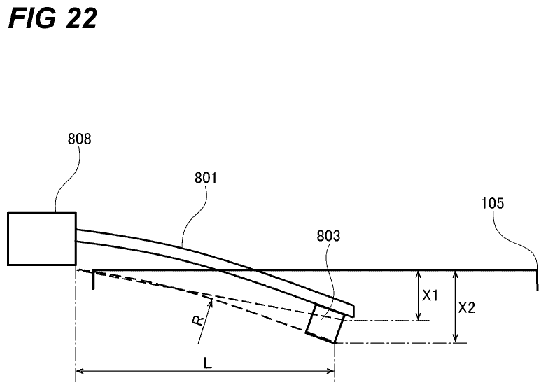

Here, as illustrated in FIG. 22, a case where the cleaning rod 801 has a curved shape in advance is considered. The cleaning rod 801 has a curved shape with a curvature R. Since the deflection amount of an arc of the curvature R is R√ (1−L\hat{ }2), the relationship between an entering amount X2 and the free length L at this time is expressed by the following Expression 4.

$${X}_{2} = k L + R \sqrt{( 1 - {L}^{2} )} \qquad ( Expression 4 )$$

The entering amount X2 is equal to the deflection amount δ. Thus, when abutment pressure P2 of the cleaning portion 803 of the curved cleaning rod 801 is obtained by substituting the entering amount X2 of Expression 4 into the deflection amount δ of Expression 1, the following Expression 5 is obtained.

$${P}_{2} = \frac{3 EIk}{{L}^{2}} + \frac{3 EIR \sqrt{( 1 - {L}^{2} )}}{{L}^{2}} \qquad ( Expression 5 )$$

The following Expression 6 is obtained from Expression 5 and Expression 1. The second term on the right side is always positive, and has a relationship of increasing corresponding to the free length L.

$${P}_{2} = {P}_{1} + \frac{3 EIR \sqrt{( 1 - {L}^{2} )}}{{L}^{2}} \qquad ( Expression 6 )$$

Therefore, as the curved cleaning rod 801 is inserted, the increase amount of the entering amount X2 with respect to the free length L becomes larger than the case where the cleaning rod 801 has a straight shape. That is, it is possible to alleviate the decrease in the abutment pressure due to the increase in the insertion amount of the cleaning rod 801.

As described above, regarding the shape of the cleaning rod 801, the shape having a predetermined R can obtain more stable cleaning ability regardless of the insertion position than the straight shape. As an example, the manner of curving the cleaning rod 801 has been exemplified as a simple R shape that is relatively easily manufactured. However, the shape is not necessarily a predetermined R shape, and may be a shape having an inflection point on the way or a shape in which R continuously changes as long as the shape is curved toward the optical print head 105 as it goes toward the tip.

### Other Examples

In the above-described example, four image forming portions are used, but the number of used image forming portions is not limited, and may be appropriately set as necessary.

Further, in the above-described example, the printer has been exemplified as the image forming apparatus, but the present disclosure is not limited thereto. For example, another image forming apparatus such as a copying machine or a facsimile machine, or another image forming apparatus such as a multifunction peripheral combining these functions may be used. The image forming apparatus has been exemplified in which an intermediate transfer member is used, toner images of respective colors are transferred to the intermediate transfer member in a sequentially superimposed manner, and the toner images carried on the intermediate transfer member are collectively transferred to a recording material, but the present disclosure is not limited thereto. The image forming apparatus may be an image forming apparatus that uses a recording material carrier and transfers toner images of respective colors on the recording material carried on the recording material carrier, in a sequentially superimposed manner. Similar effects can be obtained by applying the present disclosure to these image forming apparatuses.

According to the present disclosure, it is possible to reliably clean the lens of the optical print head.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-032922, filed Mar. 3, 2025, which is hereby incorporated by reference herein in its entirety.

What is claimed is:

1. An image forming apparatus comprising:
a photosensitive member;
an optical print head configured to expose the photosensitive member and include a substrate on which a plurality of light emitting elements is mounted along a longitudinal direction that is an axis direction of the photosensitive member, and a lens array including a plurality of lenses configured to condense light emitted from the light emitting elements on the photosensitive member;
a cleaning rod configured to have a longitudinal shape, be inserted from an outside of the image forming apparatus, and clean an emission surface of the lens by rubbing the emission surface of the lens in the longitudinal direction; and
a guide member configured to guide the cleaning rod inserted from the outside of the image forming apparatus in the longitudinal direction while causing the cleaning rod to abut on the emission surface of the lens, wherein
the guide member includes
a first restricting portion configured to restrict a movement of the cleaning rod abutting on the lens in a direction away from the optical print head, and
a second restricting portion that is provided on an upstream side of the first restricting portion in an insertion direction of the cleaning rod and is configured to restrict movement of the cleaning rod abutting on the first restricting portion in a direction approaching the optical print head.

2. The image forming apparatus according to claim 1, wherein
the cleaning rod includes a restriction target portion configured to pass between the first restricting portion and the second restricting portion of the guide member and be restricted by abutting on the first restricting portion and the second restricting portion, and
a thickness of the restriction target portion in an optical axial direction perpendicular to the longitudinal direction is larger than a first interval between the second restricting portion and the first restricting portion in the optical axial direction.

3. The image forming apparatus according to claim 1, wherein
the guide member includes
a third restricting portion that is provided on an upstream side of the first restricting portion in the insertion direction, is provided on an upper side of the first restricting portion in an optical axial direction perpendicular to the longitudinal direction, and is configured to restrict movement of the cleaning rod in the direction away from the optical print head, and
a fourth restricting portion that is provided on a downstream side of the second restricting portion in the insertion direction, is provided on a lower side of the second restricting portion in the optical axial direction, and is configured to restrict movement of the cleaning rod in the direction approaching the optical print head.

4. The image forming apparatus according to claim 3, wherein
the cleaning rod includes a restriction target portion configured to pass between the third restricting portion and the second restricting portion and between the first restricting portion and the fourth restricting portion and be restricted by abutting on the first restricting portion and the second restricting portion, and
a thickness of the restriction target portion in the optical axial direction is smaller than a second interval between the third restricting portion and the second restricting portion in the optical axial direction and is smaller than a third interval between the first restricting portion and the fourth restricting portion in the optical axial direction.

5. The image forming apparatus according to claim 2, wherein
the restriction target portion included in the cleaning rod is provided on each of left and right sides in a width direction perpendicular to the longitudinal direction and the optical axial direction, and the restriction target portions are respectively restricted by the second restricting portion and the first restricting portion.

6. The image forming apparatus according to claim 1, wherein
the cleaning rod includes a cleaning portion configured to clean the emission surface of the lens, and the cleaning portion is an elastically deformable member.

7. The image forming apparatus according to claim 1, wherein
the guide member is provided on a front side of the optical print head in the insertion direction on an extension line of the lens in the longitudinal direction.

8. The image forming apparatus according to claim 1, wherein
the optical print head is provided to be movable between an exposure position where the photosensitive member is exposed and a retraction position farther away from the photosensitive member than the exposure position, and
the guide member guides the cleaning rod between the photosensitive member and the optical print head retracted to the retraction position.

9. An image forming apparatus comprising:
a photosensitive member;
an optical print head configured to expose the photosensitive member and include a substrate on which a plurality of light emitting elements is mounted along a longitudinal direction that is an axis direction of the photosensitive member, and a lens array including a plurality of lenses that condense light emitted from the light emitting elements on the photosensitive member; and
a guide member configured to guide a cleaning rod inserted from the outside of the image forming apparatus in the longitudinal direction while causing the cleaning rod to abut on the emission surface of the lens, the cleaning rod being configured to have a longitudinal shape and clean an emission surface of the lens by rubbing the emission surface of the lens in the longitudinal direction, wherein
the guide member includes
a first restricting portion configured to restrict a movement of the cleaning rod abutting on the lens in a direction away from the optical print head, and
a second restricting portion that is provided on an upstream side of the first restricting portion in an insertion direction of the cleaning rod and is configured to restrict movement of the cleaning rod abutting on the first restricting portion in a direction approaching the optical print head.
